(19) United States
(12) Patent Application Publication
(10) Pub. No.: US 2005/0229827 A1
(43) Pub. Date: Oct. 20, 2005

(54) Multi-flora, low-maintenance, landscaping

(76) Inventor: Linton Wright McKnight, Milledgeville, GA (US)

Correspondence Address: DAVID M. GESHWIND;UINPAT.ORG, SUITE 36J, 529 LINCOLN SQUARE, NEW YORK, NY, 10023, US

(21) Appl. No.: 10/827,226

(22) Filed: Apr. 19, 2004

(51) Int. Cl. A01G 29/00; A01C 11/00; A01G 23/02

(52) U.S. Cl. 111/100

(57) ABSTRACT

Low-maintenance, multi-flora landscaping techniques provide robust year-round, or nearly year round, decorative environments.

### BACKGROUND OF THE INVENTION

1. Field of the Invention

Generally, the instant invention relates to low-maintenance, multi-flora landscaping techniques that provide a robust year-round, or nearly year round, decorative landscaped environment.

2. Description of Related Art

The instant invention has been made in the general realm of landscaping. However, these are techniques specifically directed toward providing a decorative environment year-round, or at least during a large part of the year, as well as requiring, after installation, little to no maintenance.

A long history and large number of planting and landscaping techniques exist; yet, the instant invention is patentably distinct from those, providing the benefits mentioned above. Nevertheless, the extant art is rife with methods and devices that will prove useful, to those who are not skilled in the appropriate art, for implementing certain elements of the instant invention.

For example, U.S. Pat. No. 3,992,184 issued Nov. 16, 1976 to Baldock for “Slow-release fertilizers” teaches a “fertilizer from which potassium is released slowly.” And, U.S. Pat. No. 5,849,060 issued Dec. 15, 1998 Diping, et al. for a “Controlled release fertilizer and preparations thereof” teaches “a controlled release fertilizer having water-soluble fertilizers as nucleus and limited-soluble plant nutrient compounds as coating layers . . . and that the release rates of the fertilizer can be controlled by regulating the solubilities of the limited-soluble compounds. The invention also relates to a process for preparing the controlled release fertilizer.”

Further, U.S. Pat. No. 4,615,642 issued on Oct. 7, 1986 to Mason for a “Variable porosity irrigation pipe” teaches how a “Porous pipe having a porosity which varies continuously and controllably with length is produced by extruding a mixture of particles of prevulcanized elastomer such as reclaimed crumb rubber and a thermoplastic binder such as polyethylene with all parameters controlled except for die temperature of pull-off rate. By gradually varying temperature or pull-off rate during extrusion, the porosity of the pipe gradually changes. The leak rate can be controlled in a manner to produce a length of porous pipe in which the leak rate is constant as the pressure drops over the length of the pipe.”

It is assumed, in the discussion below, that the reader is familiar with the basics of gardening and/or landscaping, and other related activities.

The intended practitioner of the present invention is someone who is skilled in designing, implementing, installing, or otherwise creating and maintaining outdoor plantings or landscapes in private or public venues including areas surrounding homes, commercial buildings, highways and other thoroughfares, parks, gardens, etc. That is, one skilled in the art required to practice the instant invention is capable of one or more of the following: design of landscaping plans; selection of plants suitable to regional and location specific elements such as light exposure, hydration, etc.; excavating dirt and preparing soil mixtures including the adding of elements to control moisture and prevent erosion or weed intrusion; the use of mulches, fertilizers, herbicides, pH adjusters and other additives; the planting and watering of various flora; the installation and operation of hoses or other watering devices; etc.

The details of accomplishing such standard tasks are well known and within the ken of those skilled in those arts; are not (in and of themselves, except where noted) within the scope of the instant invention; and, if mentioned at all, will be referred to, but not described in detail, in the instant disclosure.

Rather, what will be disclosed are novel techniques and configurations of preparing and arranging soil and other elements; installing watering devices; and, selecting and planting a variety of flora to achieve the above mentioned benefits.

In summary, the disclosure of the instant invention will focus on what is new and novel and will not repeat the details of what is known in the arts.

### BRIEF DESCRIPTION OF DRAWINGS

FIG. 1 depicts an over-head view of the amended soil berm and multi-flora plantings.

FIG. 2 depicts a cross-section of the amended soil berm and drainage trenches.

FIG. 3 depicts a detail of a planting in the amended soil berm.

FIG. 4 depicts a flow diagram for creating the amended soil berm and drainage trenches.

FIG. 5 depicts a chart of a preferred selection of plants, the number of plants per 100 feet of berm, their time of blooming (in the Southeastern United States) and approximate height range.

### DETAILED DESCRIPTION OF PREFERRED EMBODIMENTS WITH REFERENCE TO THE DRAWINGS

The LinLine™ approach to landscaping provides a multi-flora, year-round (or nearly year-round) robust, low-maintenance decorative environment. It is suitable for use in residential, commercial, industrial, or public spaces such as gardens, parks or along highways or other thoroughfares.

Preparation of the Planting Area

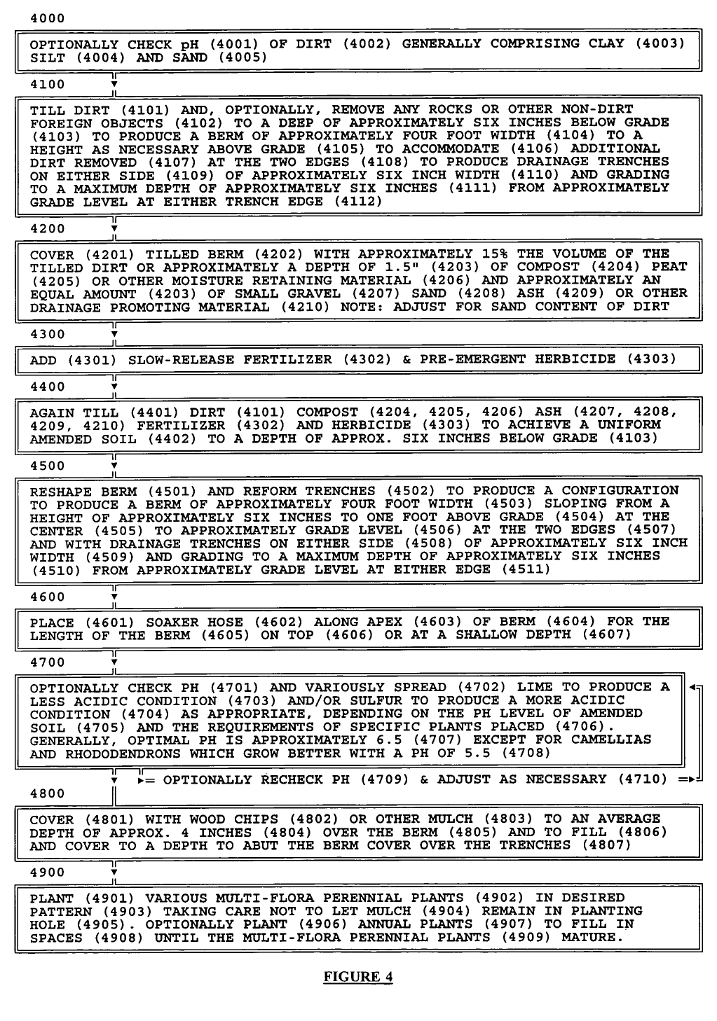

Preparation of the planting area is key to the low maintenance aspect of the invention. Typical scenarios for the process are described below and shown in FIG. 4. However, as is natural, certain steps which are articulated as distinct and ordered may be combined and/or ordered differently. In particular, for example, when tilling the volume of soil that is to become the berm, and excavating the two longitudinal trenches at its sides, one may, optionally: till a four foot wide area, and excavate the trenches placing that dirt on top; or, excavate the trenches, placing the dirt on top and then tilling the four foot wide central area (however, this might tend to refill the trenches); or, one might combine these operations by tilling a five foot wide area to a depth of six inches and then excavating two six inch wide channels of loosened earth at the longitudinal sides, placing this earth on top of the central four foot wide area to create a berm. Such variations and deviations from the specific processes articulated, or depicted, are within the scope of the invention; and, it is that the desired result be achieved which is important, rather than the exact organization and sequencing or steps be adhered to.

The planting area to be prepared is approximately five feet wide and can be of indeterminate length, to accommodate a particular purpose. It can be several feet long (for example, to use in a home garden) to many miles long (as might be used on a highway divider).

Preparation begins by first determining the pH (4000) of the dirt to determine if it must be modified to accommodate the particular plants that are to be installed.

Next, the area of the berm and trenches is tilled (4101) to a depth of six inches below grade, or to the same depth of the planned trenches.

The next step is the excavation of two parallel trenches (4109) along the lengthwise edges of the tilled area, roughly parabolic in shape, each approximately six inches in depth six inches in width at the top, and of whatever length has been selected for the installation.

The dirt removed from the excavated trenches is then placed between the two trenches to form a berm (4107).

The next step can vary depending upon the composition of the dirt. For the majority of dirt types, (including those containing a large amount of clay or silt) a mixture composed of equal parts compost (or other water retaining material) and ash, sand (or other drainage material) is spread over the berm to a depth of approximately three inches, to produce a dirt to ash to compost ratio in the range of approximately 4:1:1 to 2:1:1. (4200) This mixture is adjusted depending on the composition of the dirt. For example if the dirt contains large amounts of sand, the amount of ash should be adjusted downward to accommodate the excess sand, even to the extent of not adding any drainage material at all. In such a case, additional compost should be added to produce an amended soil mixture where there is approximately an equal ratio of compost to natural sand and added ash in combination.

Also spread over the berm is a pre-emergent herbicide (4303) and a slow release fertilizer (4302).

The berm is then further tilled to create a relatively uniform mixture of soil, ash or sand, compost, fertilizer and herbicide down to a depth of six inches below grade (4103). The berm should be approximately six inches to one foot above grade at the apex and gradually slope down to grade level at the inner edges of the trenches on either side (4501). At the edges of the trenches the slope of the berm should increase to form the inner walls of the trenches. Again the trenches are cleared to regain their shape (4502).

A soaker hose (4602) is placed at the apex of the entire length of the berm (4603). It can either be laid directly on the surface or buried an inch or two under the surface (4600).

Optionally, depending upon the pH of the soil, as was determined prior to beginning the excavation, the soil is treated with (for example) lime to raise the pH; or sulfur to lower the pH to an optimal level of approximately 6.5. (4700)

Certain plants such as camellia and rhododendron thrive best in a more acidic soil (with a pH in the range of 5.5) so the berm soil can be specifically treated in the areas where these particular plants are to be placed to adjust the soil locally rather than treat the entire berm (4708).

The amended soil mixture can be retested for pH at this point and further adjusted (4710).

The next two steps comprise the placing of mulch on the berm and installation of the plants. These steps can be performed in either order. Which is preferable depends upon the application.

For extremely long installations, it is generally more practical to first place a layer of mulch (such as wood chips, pine needles or even additional compost) approximately four inches thick over the surface of the berm and fill in the trenches with mulch on both sides of the berm giving a depth of mulch in and over the trenches to approximately 2 inches above grade. The mulch will tend to slip down the side of the berm and become thicker near the trenches. The goal is to create a relatively smooth layer of mulch over the entire berm and both trenches. The mulch should be, at the apex of the berm, its thinnest part, at least two inches thick.

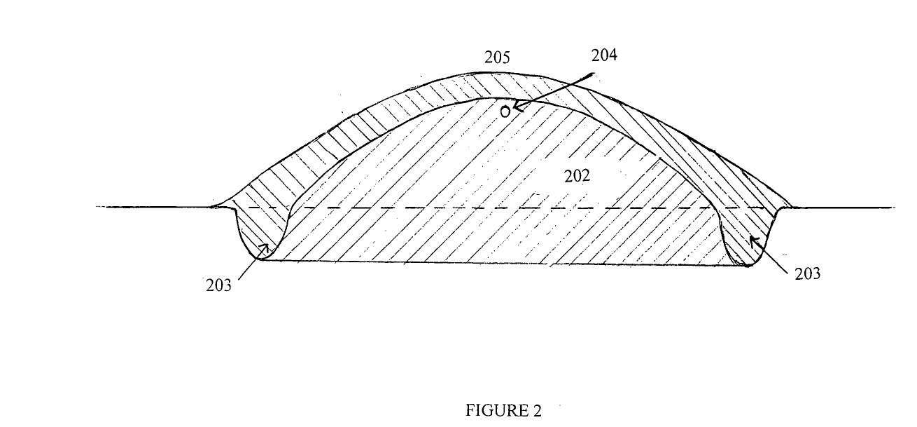

The completed berm is shown in FIG. 2. The berm containing the amended soil (202) is shown approximately one foot above grade (206) and 6 inches below. The berm contains a soaker hose located at its apex (205) approximately one inch below the surface of the amended soil. The berm is flanked by two drainage trenches (203) approximately 6 inches in depth and six inches across at their top. The berm and trenches are covered by a layer of mulch (201) which is thinnest at the apex of the berm (205) and over fills the drainage trenches to a depth of approximately two inches above grade (206).

Installation of the plants is then done taking care not to bury mulch when the plants are put in. This is important because, if using a mulch that has not yet decomposed, any mulch buried with the plant will absorb nitrogen from the soil as it decomposes depriving the plant of an essential nutrient.

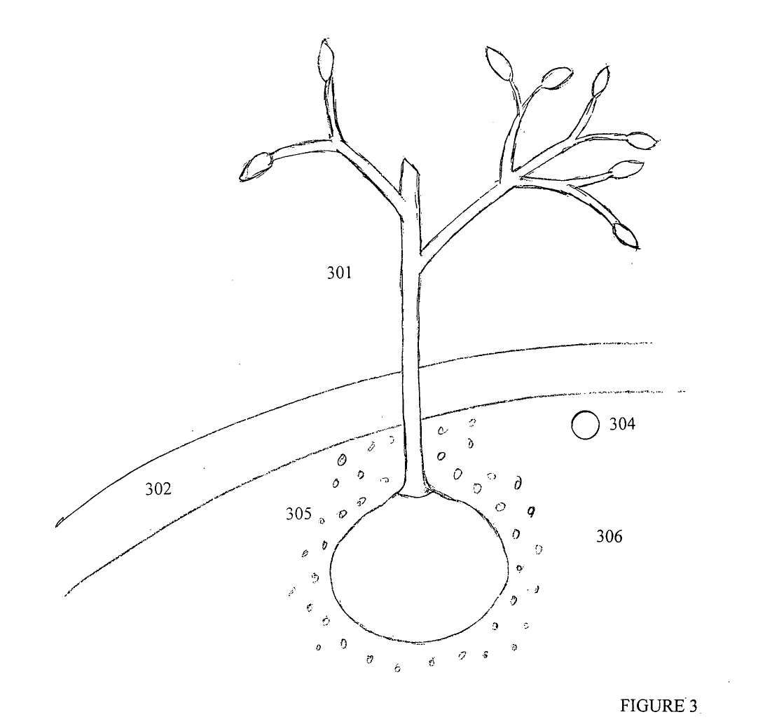

FIG. 3 shows the placement of a plant, such as a rhododendron, in the berm. The plant has been planted in the amended soil (304) near the soaker hose (304). The soil has been further amended by the introduction of sulphur to make the soil more acidic (305) which is more appropriate for that particular plant. The plant has been placed below the mulch layer (302) and care has been taken to ensure that no mulch entered the hole during planting.

For small installations, installation of the plants can be done first, with the layer of mulch placed on after planting. This is more labor intensive, but avoids the problem with mulch being buried with the plant roots. If compost or other substance which has already gone through the decomposition process is used as mulch, this is not a problem, however the use of such material as a mulch is less cost effective.

Optionally, additional annual or semi-annual plants or ground cover plants can also be placed between the selected perennial plants. These will help prevent the growth of weeds until the perennial plants have matured. Once mature, the selected perennial plants will minimize weed growth.

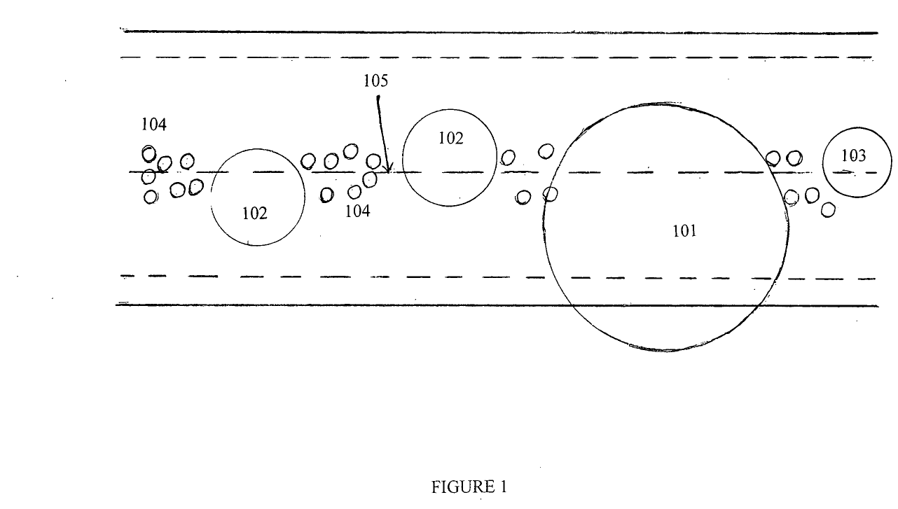

The perennial plants should generally be planted near the center of the berm, close to the soaker hose (105). Plants should be spaced to provide visual interest. An example of the placement of various plants is shown in FIG. 1. In the preferred embodiment four groups of plants are used for the installation. The first type (101) consists of the largest plant used, the Lagerstroemia (Crape Myrtle). The second type (102) are Canna and Forsythia. The third type (103) are medium sized shrubs such as Rose, Hydrangea, Rhododendron and Camellia. Lastly are the smallest plants (104), which consists of Iris, Phlox, Hemerocallis (Day Lily), Chrysanthemum, and Narcissus. This selection of plants is exemplary and should not be considered to limit the invention. An exception to the general instruction of placing plants at the apex of the berm is the situation where the berm is used on or near highways or anywhere where visibility for drivers or pedestrians is an issue. In that case larger plants may be placed on the edge of the berm further away from the road or sidewalk to avoid creating a dangerous situation.

Advantages of Berm Design

The particular construction of the berm provides numerous advantages over the typical plant installation found in gardens and on highway landscaping.

A first advantage is provided by the narrow profile of the berm. This makes the entirety of the installation easy to reach by those constructing and maintaining it.

A second advantage is achieved by the composition of the amended soil used for planting. By mixing dirt, ash or sand, compost, pre-emergent herbicide and slow release fertilizer, the invention provides a friable planting surface with excellent drainage, protection against the germination of weeds, and a nutrient rich environment for plants to grow without extensive maintenance.

A third advantage is provided by the shape of the berm and the presence and location of the soaker. Under ordinary conditions, that of a soaker being placed on flat, unamended soil, a soaker will only hydrate an area of approximately eighteen inches wide. The placement of the soaker at the top of the berm, combined with the excellent drainage of the amended soil and the curved shape of the berm results in the soaker hydrating the entire four foot wide planting area. This avoids the need for extensive watering or sprinkler systems, which are more expensive, and either labor or maintenance intensive.

The shape of the berm coupled with the trenches provide a runoff mechanism which prevents excessive moisture from rain from destroying the plants. Thus, both the problems of too little or too much moisture, which are the primary reason plants do not survive, are automatically compensated for.

Mulch, placed over the berm and in the trenches, absorbs water, protects the soil from erosion due to runoff, prevents excess evaporation, helps prevent weed intrusion, and provides slow-release nutrient value. The trenches also provide a reservoir for mulch that moves due to wind or rain and which can be pushed back over the berm providing for easy maintenance and reduced replacement cost. Depending upon the type of mulch used (which is generally determined by availability and cost) it can also be aesthetically pleasing.

Selection of Plants

While the berm construction can be used to advantage with numerous varieties of plants, it is particularly suitable to creating an installation which allows for the use of plants that are very robust, require little care, and flower in sequence throughout the year. The selection of plants varies from trees with heights of up to 25 feet, to plants that can be as small as four inches in height. These combinations provide visual interest. The plants are also arranged to enhance the environment of other plants. For example, trees are placed so that they provide shade for those plants that flourish out of direct sunlight allowing for the planting of several species where they would not ordinarily thrive. An example of the planting arrangement is shown in FIG. 1.

Plants are also selected so that, when they reach their mature size they will naturally prevent the growth of weeds, thereby substantially reducing the amount of herbicides needed and reducing the amount of labor needed to maintain the landscaped area. This reduces costs for both herbicides and labor, and also has the substantial added benefit of being environmentally preferable.

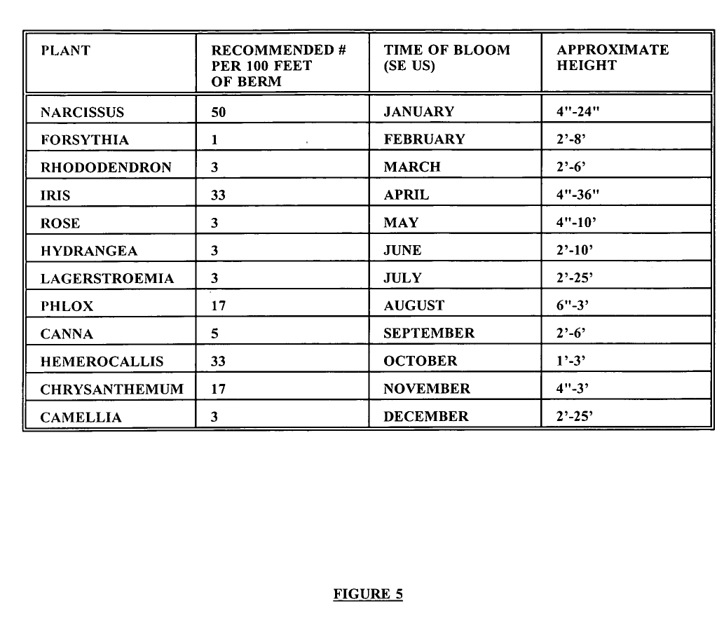

A chart of a preferred selection of plants, the number of plants per 100 feet of berm, their time of blooming (in the Southeastern United States) and approximate height range is shown in FIG. 5.

With regard to the selection of the Lagerstroemia (Crape Myrtle), either a tree form or dwarf variety may be used. In particular, if the area of the planting is in direct sunlight, the tree form may be more suitable because it will permit the camellias and rhododendrons to be planted in the shade of the tree which is a more suitable environment.

FIG. 3 shows a detail example of the placement of a plant within the berm.

While obtaining a year round flowering is a goal of the invention, in areas where there is snow and frost, plants will not flower when in constant below freezing temperatures. In those cases where the specified plants will not thrive in a colder environment, substitutions of more suitable plants are, optionally, made. Further, although the approximate flowering dates provided above will be delayed the farther north the installation is planted, the order in which the plants will bloom will usually be maintained.

It is within the scope of the instant invention, that substitutions for the various plants can be made for aesthetic, climatological, cost, maintenance or other reasons. Such variations are within the scope of the instant invention.

### Intellectual Property

The choice and layouts of plants, configuration of soil placement, composition of amended soil, use of herbicides, fertilizers, mulches, etc., processes of carrying out the instant invention, steps described and/or depicted in any flow diagram, and other elements disclosed herein, are exemplary and not necessarily shown to scale. A number of alternatives for each element have been disclosed, as have specific choices of alternatives comprising some specific preferred embodiments. In particular: the proportions of dirt, compost (or equivalent), ash (or equivalent); the dimensions of the berm or trenches; the depths or amounts of mulch, herbicides, fertilizers, lime, sulphur or other additives; the selection of plants; type and placement of soaker device; method of watering, drainage, fertilizing, weed control, planting; etc. may be, optionally, adjusted without straying from the intended scope of the instant invention. To whatever degree these alternatives are not in conflict, any and all of the alternatives for any element are practiced, in any combination, with any and all of the alternatives for other elements, in order to create alternative preferred embodiments of the instant invention. In particular, the choice of plants may, optionally, be substituted, subtracted from, or added to, for the purposes of: economic or logistic availability; geographic or climatic appropriateness or robustness; according to the availability of sunlight and/or water; variety or to achieve multiple simultaneous display; and, in particular, in some areas year-round plants, such as evergreens may, optionally, be used in lieu of plants that display only in the wintertime. Furthermore, certain steps or other elements may be ordered or arranged differently, combined, separated, modified or eliminated entirely, without deviating from the intended scope of the invention. In addition, substitution, such as alternative moisture retention materials, drainage materials, mulches, watering devices, plant selections; or modified or alternative configurations; etc. are within the scope of the instant invention.

Further, these elements can be combined with elements of other techniques, now in existence or later developed, without deviating from the intended scope of the invention. Additionally, employment any method of construction, planting or maintenance of physical landscaping techniques described herein, now known or later developed, is intended to be within the scope of the instant invention.

The contents of the disclosure of this patent document, and the accompanying figures, is copyright to the inventor and/or practitioner. The copyright owners have no objection to the facsimile reproduction (but not further publication or distribution) of the patent document or the patent disclosure, as it appears as issued by the Patent and Trademark Office, to the extent permitted by law. Written permission of the appropriate copyright holder must be obtained for any other use. Copyright holder otherwise reserves all copyright rights whatsoever, including the right to excerpt, compile or otherwise alter or adapt, or make any other use of, this information.

Further, the name LinLine™ and other names, plant selections, and any other trademarkable elements of the instant invention, are trademarked to the inventor.

In any event, any publication of or about any of the information contained herein must contain appropriate patent, trademark and copyright notices.

It will thus be seen that the objects set forth above, among those made apparent from the preceding description, are efficiently attained and certain changes may be made in carrying out the above method and in the construction set forth. Accordingly, it is intended that all matter contained in the above description or shown in the accompanying figures shall be interpreted as illustrative and not in a limiting sense.

Now that the invention has been described, what is claimed as new and desired to be secured by Letters Patent is:

1. A method for providing a low-maintenance landscape comprising:
a. tilling dirt within a volume comprising a relatively shallow depth below grade, for a relatively wide width, and for an arbitrary relatively longer than wide length;
b. excavating a drainage trench along at least one lengthwise side of said volume, of a relatively shallow depth and relatively narrow width, adding the excavated dirt to the tilled dirt;
c. optionally removing rocks and other non-dirt objects;
d. mixing with said dirt an amount less than that of said dirt of moisture retaining material substantially functionally equivalent to compost;
e. mixing with said dirt an amount less than that of said dirt of drainage promoting material substantially functionally equivalent to ash, said amount being adjusted in accordance with the sand content of said dirt;
f. forming the resultant mixture of dirt, compost equivalent and ash equivalent into a berm sloping from approximately grade level at the edges to a higher elevation toward the long axial center;
g. covering said berm, and filling and covering said trench(s), with a substantially continuous and stable layer of mulch material substantially functionally equivalent to wood chips; and,
h. planting a multiplicity of plants in said berm.

2. A method as in claim 1, wherein said at least one side in step b. is both sides.

3. A method as in claim 2 wherein, in addition, slow-release fertilizer is added to the mixture of step e.

4. A method as in claim 2 wherein, in addition, pre-emergent herbicide is added to the mixture of step e.

5. A method as in claim 2 wherein, in addition, an alkaline substance substantially functionally equivalent to lime is added to the mixture of step e. to adjust the pH of the dirt and/or amended soil mixture.

6. A method as in claim 2 wherein, in addition, an acidic substance substantially functionally equivalent to sulphur is added to the mixture of step e. to adjust the pH of the dirt and/or amended soil mixture.

7. A method as in claim 2 wherein, in addition, an alkaline substance substantially functionally equivalent to lime is added to at least one selected area of the mixture of step e. to adjust the pH for a particular plant.

8. A method as in claim 2 wherein, in addition, an acidic substance substantially functionally equivalent to sulphur is added to at least one selected area of the mixture of step e. to adjust pH for a particular plant.

9. A method as in claim 2 wherein, in addition, a hydration device is placed upon and/or within said berm.

10. A method as in claim 9, wherein said hydration device comprises a soaker hose running along substantially the entire length of said berm placed at a shallow depth below the apex of said berm.

11. A method as in claim 2 wherein:
i. the maximum depth and width of said drainage trenches are substantially six inches each;
j. the width of said berm is substantially four feet;
k. the depth of said berm below grade is substantially six inches;
l. the height of said berm above grade slopes from substantially grade level at the edges to a height of substantially between 3 and 9 inches above grade at the longitudinal axial center;
m. the length of said berm, or a substantially contiguous series of said berms, is at least several multiples of said width;
n. the combination of materials in steps d. and e. in combination is substantially between 20% and 60%, with a recommended target of substantially 33%, of the total mixture of step f.; and,
o. the mulch in step g. is a substantially continuous and stable layer substantially a minimum of two inches and substantially an average of four inches over said berm, and substantially fills and adjoins the said layer over said berm over said drainage trenches.

12. A method as in claim 11 comprising, in addition:
p. a soaker hose running along substantially the entire length of said berm or berms, placed at a depth of less than two inches below the apex of said berm;
q. slow-release fertilizer and pre-emergent herbicide are added to the mixture of step f; and,
r. and acidic and/or alkaline additive is optionally added to the mixture of step f as appropriate.

13. A method as in claim 2, wherein said multiplicity of plants, comprises a climatologically appropriate selection chosen to produce a year-round, or nearly year-round, decorative display.

14. A method as in claim 13, wherein said multiplicity of plants, producing a year-round, or nearly year-round, decorative display, comprises a choice of plants with a display schedule substantially equivalent to, in the Southeastern United States, of:
i. Narcissus;
ii. Forsythia;
iii. Rhododendron;
iv. Iris;
v. Rose;
vi. Hydrangea;
vii. Lagerstroemia;
viii. Phlox;
ix. Canna;
x. Hemerocallis;
xi. Chrysanthemum; and,
xii. Camellia.

15. A method as in claim 14, wherein said multiplicity of plants comprises:
i. Narcissus;
ii. Forsythia;
iii. Rhododendron;
iv. Iris;
v. Rose;
vi. Hydrangea;
vii. Lagerstroemia;
viii. Phlox;
ix. Canna;
x. Hemerocallis;
xi. Chrysanthemum; and,
xii. Camellia.

16. A method as in claim 12, wherein said multiplicity of plants, comprises a climatologically appropriate selection chosen to produce a year-round, or nearly year-round, decorative display.

17. A method as in claim 16, wherein said multiplicity of plants, producing a year-round, or nearly year-round, decorative display, comprises a choice of plants with a display schedule substantially equivalent to, in the Southeastern United States, of:
i. Narcissus;
ii. Forsythia;
iii. Rhododendron;
iv. Iris;
v. Rose;
vi. Hydrangea;
vii. Lagerstroemia;
viii. Phlox;
ix. Canna;
x. Hemerocallis;
xi. Chrysanthemum; and,
xii. Camellia.

18. A method as in claim 17, wherein said multiplicity of plants comprises:
i. Narcissus;
ii. Forsythia;
iii. Rhododendron;
iv. Iris;
v. Rose;
vi. Hydrangea;
vii. Lagerstroemia;
viii. Phlox;
ix. Canna;
x. Hemerocallis;
xi. Chrysanthemum; and,
xii. Camellia.

19. A system for landscaping comprising a climatologically appropriate selection of a multiplicity of plants, chosen to produce a year-round, or nearly year-round, decorative display.

20. A system as in claim 19, wherein said multiplicity of plants, producing a year-round, or nearly year-round, decorative display, comprises a choice of plants with a display schedule substantially equivalent to, in the Southeastern United States, of:
i. Narcissus;
ii. Forsythia;
iii. Rhododendron;
iv. Iris;
v. Rose;
vi. Hydrangea;
vii. Lagerstroemia;
viii. Phlox;
ix. Canna;
x. Hemerocallis;
xi. Chrysanthemum; and,
xii. Camellia.

21. A method as in claim 20, wherein said multiplicity of plants comprises:
i. Narcissus;
ii. Forsythia;
iii. Rhododendron;
iv. Iris;
v. Rose;
vi. Hydrangea;
vii. Lagerstroemia;
viii. Phlox;
ix. Canna;
x. Hemerocallis;
xi. Chrysanthemum; and,
xii. Camellia.

22. A system for providing a low-maintenance landscape comprising:
a. a berm, or series of berms, running for a length that is relatively longer than its width, substantially four feet in width, tilled to a depth of substantially six inches below grade, and sloping from substantially grade level at the lengthwise edges to a maximum height of between 3 and 9 inches above grade along the lengthwise axial center;
b. a drainage trench at each lengthwise side substantially six inches in width and sloping down to a depth of substantially six inches;
c. the composition of the material of said berm comprising:
i. the tilled dirt of said berm;
ii. the dirt excavated from said drainage trenches;
iii. a combination of a moisture retention material substantially functionally equivalent to compost and a drainage promoting material substantially functionally equivalent to ash, said proportion between the two dependent upon how much sand (a drainage promotion material) is already present in said dirt, and said combination comprising an amount substantially between 20% and 60%, with a recommended target of substantially 33%, of the amount of tilled and excavated dirt;
iv. slow-release fertilizer;
v. pre-emergent herbicide;
vi. optional alkaline material substantially functionally equivalent to lime, as needed, to adjust for pH of the dirt or soil generally, or for at least one specific area to accommodate a particular plant; and,
vii. optional acidic material substantially functionally equivalent to sulphur, as needed, to adjust for pH of the dirt or soil generally, or for at least one specific area to accommodate a particular plant;
d. a layer of a mulching material substantially functionally equivalent to wood chips, wherein said layer is substantially continuous and stable, to a minimum depth of substantially two inches over the apex of said berm, with a recommended average depth of substantially four inches covering said berm, and fully filling in and rising above grade over and beyond said trenches as needed to smoothly adjoin the layer covering said berm; and,
e. at least one soaker hose running along substantially the entire length of said berm, or berms, placed at a depth of less than two inches below the apex, prior to the addition of said mulch layer, of said berm.

23. The system of claim 22 employing, in addition, landscaping comprising a climatologically appropriate selection of a multiplicity of plants, chosen to produce a year-round, or nearly year-round, decorative display.

24. A system as in claim 23, wherein said multiplicity of plants, producing a year-round, or nearly year-round, decorative display, comprises a choice of plants with a display schedule substantially equivalent to, in the Southeastern United States, of:
i. Narcissus;
ii. Forsythia;
iii. Rhododendron;
iv. Iris;
v. Rose;
vi. Hydrangea;
vii. Lagerstroemia;
viii. Phlox;
ix. Canna;
x. Hemerocallis;
xi. Chrysanthemum; and,
xii. Camellia.

25. A method as in claim 24, wherein said multiplicity of plants comprises:
i. Narcissus;
ii. Forsythia;
iii. Rhododendron;
iv. Iris;
v. Rose;
vi. Hydrangea;
vii. Lagerstroemia;
viii. Phlox;
ix. Canna;
x. Hemerocallis;
xi. Chrysanthemum; and,
xii. Camellia.

26. The system of claim 22, deployed along a highway or other public thoroughfare.

27. The system of claim 23, deployed along a highway or other public thoroughfare.

28. The system of claim 24, deployed along a highway or other public thoroughfare.

29. The system of claim 25, deployed along a highway or other public thoroughfare.
